(19) United States
(12) Patent Application Publication
(10) Pub. No.: US 2010/0142115 A1
(43) Pub. Date: Jun. 10, 2010

(54) BURIED CAPACITOR, METHOD OF MANUFACTURING THE SAME, AND METHOD OF CHANGING CAPACITANCE THEREOF

(75) Inventors: Hyun-Cheol Bae, Yuseong-gu (KR); Kwang-Seong Choi, Yuseong-gu (KR); Ju Yeon Hong, Yuseong-gu (KR); Jong Tae Moon, Yuseong-gu (KR); Yong il Jun, Sinseong-dong (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/499,762

(22) Filed: Jul. 8, 2009

(30) Foreign Application Priority Data
Dec. 5, 2008 (KR) 10-2008-0123216
Apr. 10, 2009 (KR) 10-2009-0031274

(51) Int. Cl. H01G 5/00; H01G 7/00; B32B 38/04

(52) U.S. Cl. 361/271; 29/25.41; 156/252

(57) ABSTRACT

Provided are a buried capacitor, a method of manufacturing the same, and a method of changing a capacitance thereof. The buried capacitor includes an upper electrode including at least one first hole, a lower electrode including at least one second hole, and a dielectric interposed between the upper electrode and the lower electrode.

### CROSS-REFERENCE TO RELATED APPLICATIONS

This U.S. non-provisional patent application claims priority under 35 U.S.C. § 119 of Korean Patent Application No. 10-2008-0123216, filed on Dec. 5, 2008 and Korean Patent Application No. 10-2009-0031274, filed on Apr. 10, 2009, the entire contents of which are hereby incorporated by reference.

### BACKGROUND OF THE INVENTION

The present invention disclosed herein relates to a buried capacitor, a method of manufacturing the same, and a method of changing a capacitance thereof.

Researches for miniaturization and cost savings of electronic devices have been in progress. Active devices constituting an electronic device are mostly realized with a high-density integrated circuit based on silicon technology such that only a few chip components are used for the active device. However, passive devices such as resistors, capacitors, and inductors, which constitute an electronic device, may not be integrated enough such that an individual passive device is attached on a circuit board through soldering. Accordingly, technological demands for integrating the passive devices have been increased in order to miniaturize electronic devices and improve the performance and reliability of passive devices therein. As a method for resolving these demands, low temperature cofired ceramics (LTCC) technology has been studied.

Once the size of a layer stacking package using the LTCC technology is determined, the size of a buried capacity therein is determined in proportion to the size of the layer stacking package. Then, a capacitance, a Q factor, and a resonance frequency of a capacitor are uniformly determined. However, due to the diversity of electronic devices, demands for a buried capacitor with various performances have been increased.

### SUMMARY OF THE INVENTION

The present invention provides a buried capacitor embedded in a layer stacking package of a predetermined size and having a structure that can be easily adjusted to have various performances.

The present invention also provides a method of changing a capacitance of a buried capacitor.

The present invention also provides a method of manufacturing a buried capacitor having the above structure.

Embodiments of the present invention provide buried capacitors including: an upper electrode including at least one first hole; a lower electrode including at least one second hole; and a dielectric interposed between the upper electrode and the lower electrode.

In some embodiments, the first hole overlaps the second hole.

In other embodiments, the number of the first holes is identical to that of the second holes.

In still other embodiments, the number of the first holes is different from that of the second holes.

In even other embodiments, the dielectric includes at least one third hole.

In yet other embodiments, the first, second, and third holes overlap each other.

In further embodiments, the upper electrode further includes a first via hole at one end portion; and the lower electrode further includes a second via hole at a position that does not overlap the one end portion.

In still further embodiments, the buried capacitors further include: sub capacitors including the upper electrode, the lower electrode, and the dielectric, and being stacked in a plurality of layers; an auxiliary dielectric interposed between the sub capacitors; a first via connecting the first via holes of the upper electrodes included in each sub capacitor; and a second via connecting the second via holes of the lower electrodes included in each sub capacitor.

In even further embodiments, sectional areas of the first hole and the second hole have a polygonal or circular form.

In other embodiments of the present invention, methods of changing a capacitance of a buried capacitor, the buried capacitor including an upper electrode, a lower electrode, and a dielectric, the upper and lower electrodes having predetermined horizontal and vertical lengths and facing each other, the dielectric being interposed between the upper and lower electrodes, include: disposing at least one first hole in the upper electrode; and disposing at least one second hole in the lower electrode.

In some embodiments, the disposing of the at least one first hole in the upper electrode includes changing a sectional area of the first hole; and the disposing of the at least one second hole in the lower electrode includes changing a sectional area of the second hole.

In other embodiments, the disposing of the at least one first hole in the upper electrode includes changing the number of the first holes; and the disposing of the at least one second hole in the lower electrode includes changing the number of the second holes.

In still other embodiments, the disposing of the at least one first hole in the upper electrode includes changing positions of the first holes; and the disposing of the at least one second hole on the lower electrode includes changing positions of the second holes.

In even other embodiments, the methods further include disposing at least one third hole in the dielectric.

In still other embodiments of the present invention, methods of manufacturing a buried capacitor include: forming an upper electrode on an upper insulation layer, the upper electrode including at least one first hole; forming a lower electrode on a lower insulation layer, the lower electrode including at least one second hole; laminating the upper insulation layer on the lower insulation layer; and performing a cofiring process to thermally melt and bond the upper insulation layer and the lower insulation layer.

In some embodiments, the methods further include forming a third hole in the upper insulation layer to overlap the first hole.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a sectional view illustrating a layer stacking package including a buried capacitor according to an embodiment of the present invention;

FIG. 2 is a plan view illustrating an upper electrode and a lower electrode of a buried capacitor according to an embodiment of the present invention;

FIG. 3A is an exploded perspective view of a buried capacitor according to an embodiment of the present invention;

FIG. 3B is a view taken along a line of I-I′ of FIG. 3A;

FIGS. 4A through 4D are sectional views illustrating manufacturing processes of the buried capacitor of FIG. 3B;

FIG. 5A is an exploded perspective view of a buried capacitor according to another embodiment of the present invention;

FIG. 5B is a cross-sectional view taken along a line I-I′ of FIG. 5A;

FIG. 6 is a plan view illustrating an upper electrode and a lower electrode of a buried capacitor according to further another embodiment of the present invention;

FIG. 7A is a sectional view illustrating a buried capacitor including the upper electrode 10 and the lower electrode 20 of FIG. 6 according to further another embodiment of the present invention;

FIG. 7B is a sectional view illustrating a buried capacitor including the upper electrode 10 and the lower electrode 20 of FIG. 6 according to further another embodiment of the present invention; and

FIG. 8 is an exploded perspective view illustrating a buried capacitor according further another embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

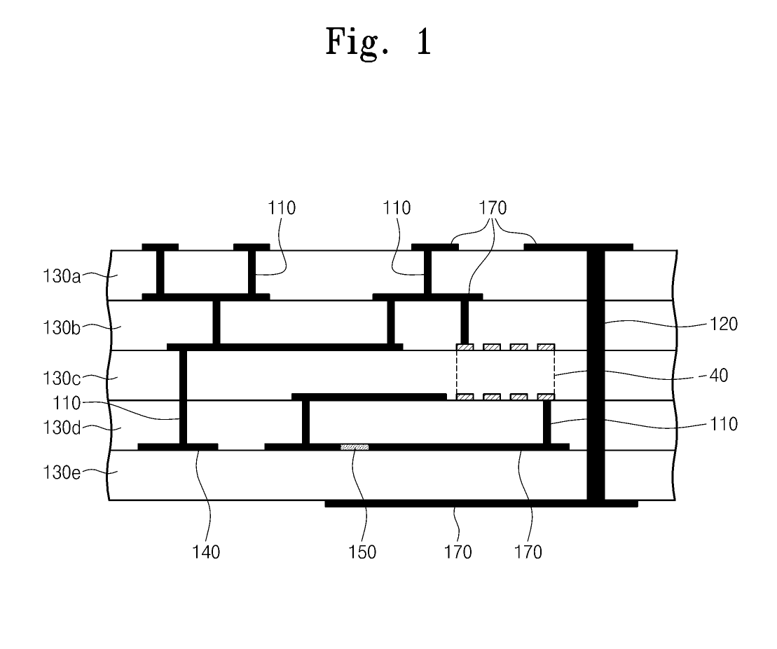

Before a buried capacitor of the present invention is described, a layer stacking package where the buried capacitor is embedded is described first with reference to FIG. 1.

Referring to FIG. 1, according to the layer stacking package to which low temperature cofired ceramics (LTCC) technology is applied, a plurality of dielectric layers 130a, 130b, 130c, 130d, and 130e are stacked, conductive patterns 170 constituting a circuit are disposed on the upper and lower surfaces. The conductive patterns 170 of each layer are connected though vias 110. Additionally, an inductor 140, a resistor 150, and a buried capacitor 40 are embedded in the layer stacking package. A thermal via 120 is disposed on one side of the layer stacking package, such that thermal emission and ground effect of a bear chip (an active device) can be provided.

Capacitors according to embodiments of the present invention, which are embedded in the same layer stacking package as FIG. 1, will be described below.

### First Embodiment

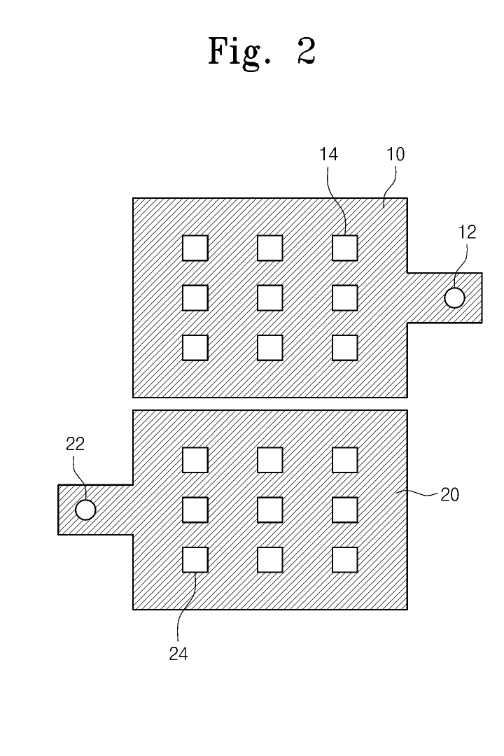

FIG. 2 is a plan view illustrating an upper electrode and a lower electrode of a buried capacitor according to an embodiment of the present invention.

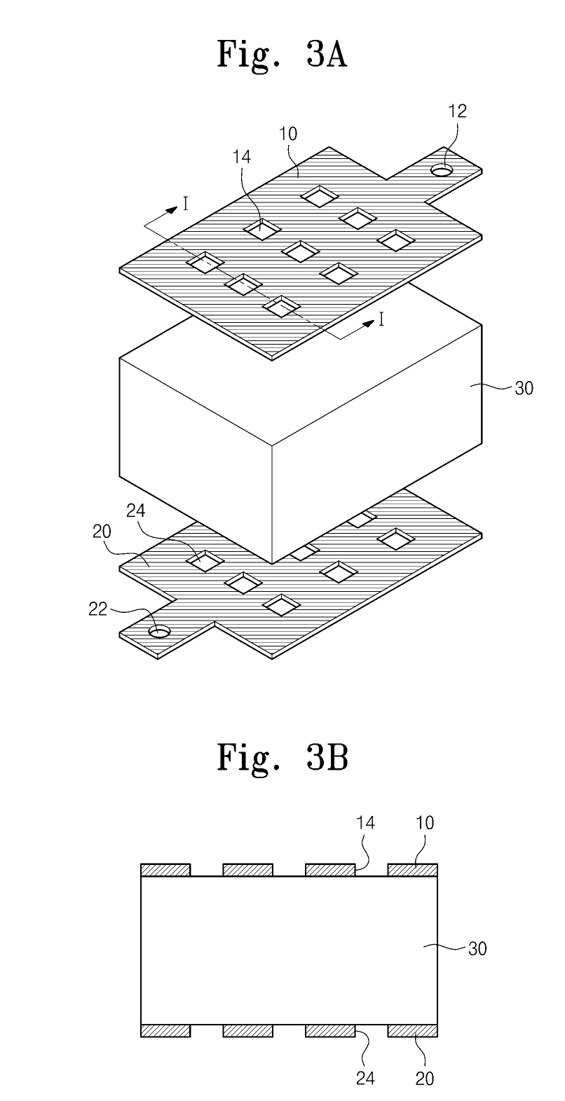

FIG. 3A is an exploded perspective view of a buried capacitor according to an embodiment of the present invention. FIG. 3B is a view taken along a line of I-I′ of FIG. 3A.

Referring to FIGS. 2, 3A, and 3B, the buried capacitor includes an upper electrode 10 and a lower electrode 20. First holes 14 are disposed in the upper electrode 10. An one end portion at one side of the upper electrode 10 protrudes and a first via hole 12 is disposed in the protruding portion. Second holes 24 are disposed in the lower electrode 20. An end portions at the other side of the lower electrode 10 protrudes and a second via hole 22 is disposed in the protruding portion. In this embodiment, the first and second holes 14 and 24 have a square form, and its number is 9 in a matrix of 3×3. A dielectric is interposed between the upper electrode 10 and the lower electrode 20, which are arranged at the upper and lower sides, respectively. At this point, the first holes 14 are aligned with the second holes 24.

In the buried capacitor of this embodiment, the holes 14 and 24 are formed in the electrodes 10 and 20, respectively. Thus, an actual area of the electrodes 10 and 20 is different from a typical capacitor including flat electrodes without holes. That is, as the number of the holes 14 and 24 is larger and a cross-sectional area of the holes 14 and 24 is larger, the actual area of the electrodes 10 and 20 becomes smaller. Therefore, a capacitance proportional to an area may become smaller. When the area is decreased, resistances of the electrodes 10 and 20 are also reduced. As a result, a Q factor can be improved. The buried capacitor of this embodiment has an advantage that a capacitance of a capacitor embedded in a layer stacking package of the predetermined standard may be changed without difficulties using the size, number, and positions of the holes 14 and 24.

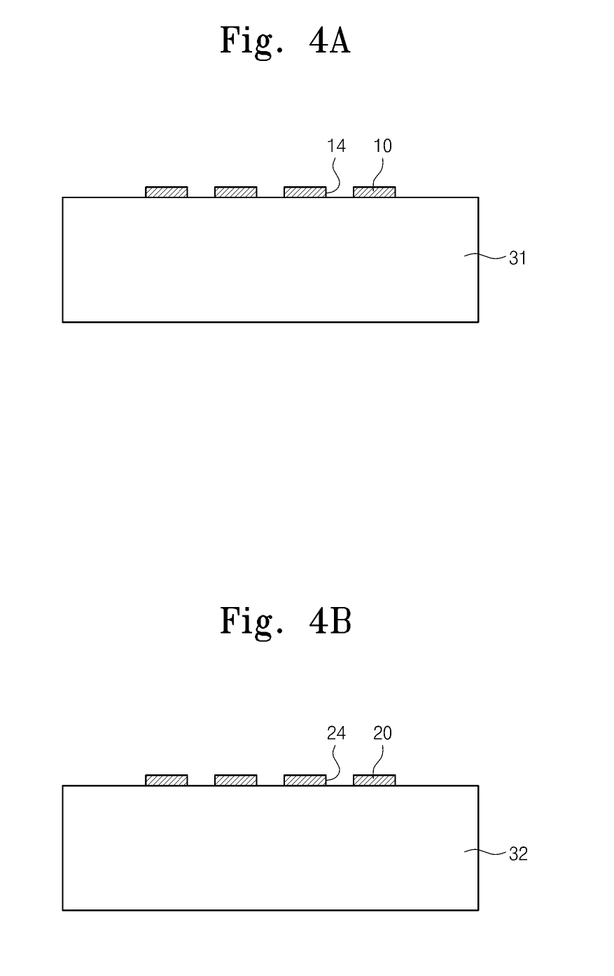

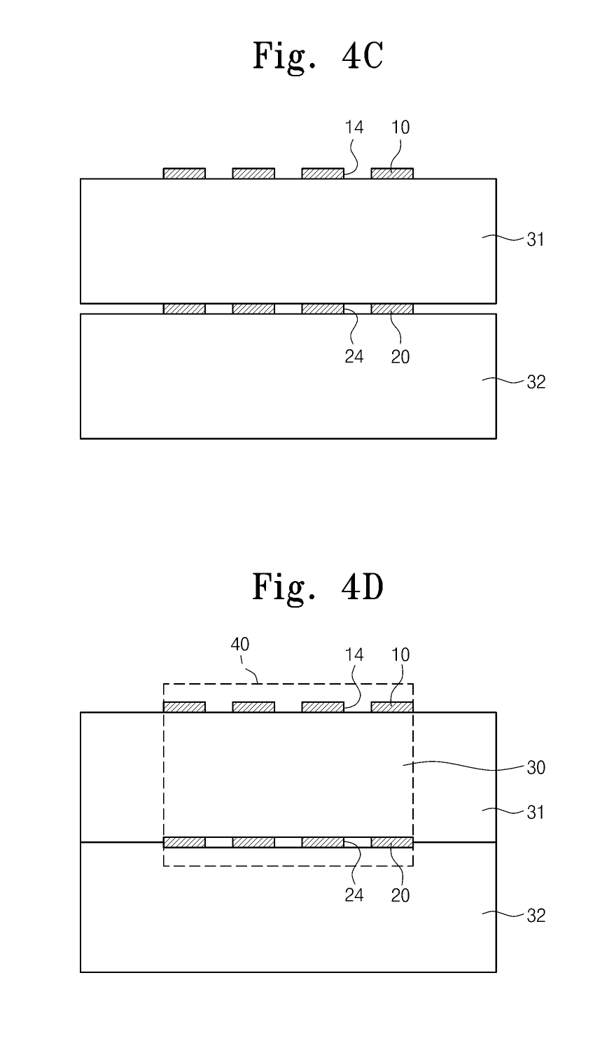

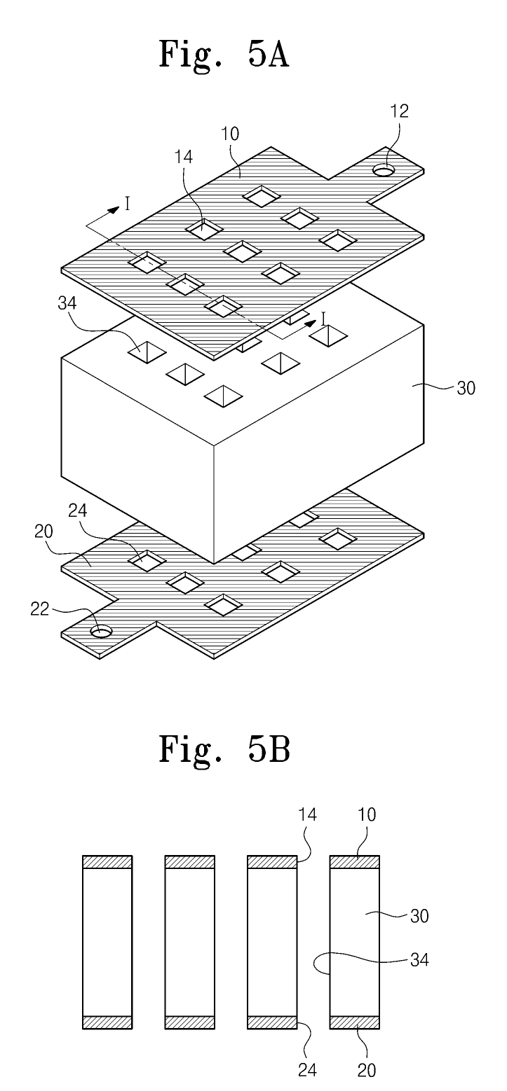

FIGS. 4A through 4D are sectional views illustrating manufacturing processes of the buried capacitor of FIG. 3B.

Referring to FIG. 4A, an upper electrode 10 having first holes 14 is formed on an upper dielectric layer 31. The upper electrode 10 may be formed of a conductive paste using a thick film screen printer.

Referring to FIG. 4B, a lower electrode 20 having second holes 24 is formed on a lower dielectric layer 32. The lower electrode 20 may be formed of a conductive paste using a thick film screen printer.

Referring to FIG. 4C, the upper dielectric layer 31 is laminated on the lower dielectric layer 32. At this point, the layers 31 and 32 may be attached to each other by applying heat and pressure. At this point, uniaxial press or isostatic press may be used.

Referring to FIG. 4D, the upper dielectric layer 31 and the lower dielectric layer 32 are thermally melted and bonded through cofiring. This cofiring process may be performed in a furnace at a temperature of about 200° C. to about 1000° C. Through this cofiring process, organic matters such as a binder in the dielectric layers 31 and 32 may be burnt out and the dielectric layers 31 and 32 are thermally melted and bonded. As time for the cofiring process is longer or a firing temperature is higher, there are good possibility that the holes 14 and 24 may be blocked by the dielectric layers 31 and 32. The upper electric layer 31 interposed between the electrode 10 and 20 corresponds to a dielectric layer 30, and the electrode 10 and 20 and the dielectric layer 30 may constitute a capacitor 40.

The formation process of the capacitor 40 described with reference to FIGS. 4A through 4D is only a portion of a forming process of the layer stacking package of FIG. 1. The capacitor 40 may be formed during the formation process of the layer stacking package. That is, like in the processes of FIGS. 4C and 4D, although not illustrated, a dielectric layer having another conductive pattern may be disposed on the upper electric layer 31 and also a firing process may be performed thereon at the same time.

### Second Embodiment

FIG. 5A is an exploded perspective view of a buried capacitor according to another embodiment of the present invention. FIG. 5B is a cross-sectional view taken along a line I-I′ of FIG. 5A.

Referring to FIGS. 5A and 5B, third holes 34 may be disposed in a dielectric layer 30. In this embodiment, the third holes 34 may have the same square form as the first and second holes 14 and 24 and also the same number at the same position. Therefore, the first hole 14, the third hole 34, and the second hole 24 may be aligned with each other. In the buried capacitor of this embodiment, like FIG. 4C, before the upper dielectric layer 31 is laminated on the lower dielectric layer 32, the upper dielectric layer 31 is punched using the first hole 14 of the upper electrode 10 as a mask. Next, a cofiring process is performed to form a buried capacitor like FIGS. 5A and 5B. In the buried capacitor, the third holes 34 are formed in the dielectric layer 30 to have a capacitance that is different from that of the capacitor of the first embodiment.

### Third Embodiment

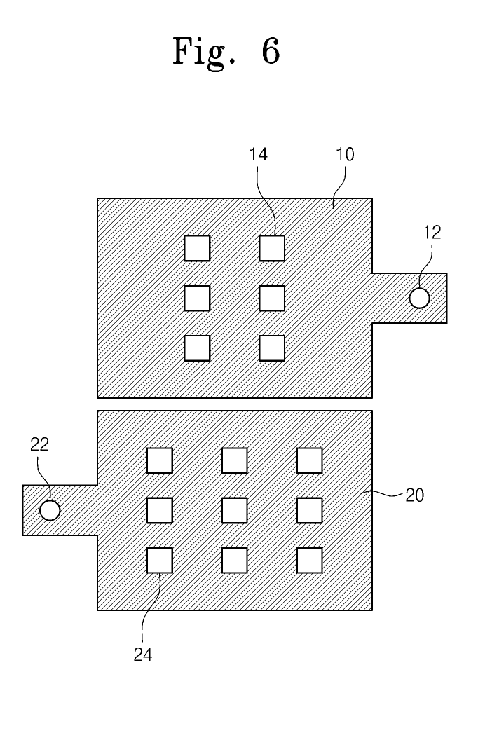

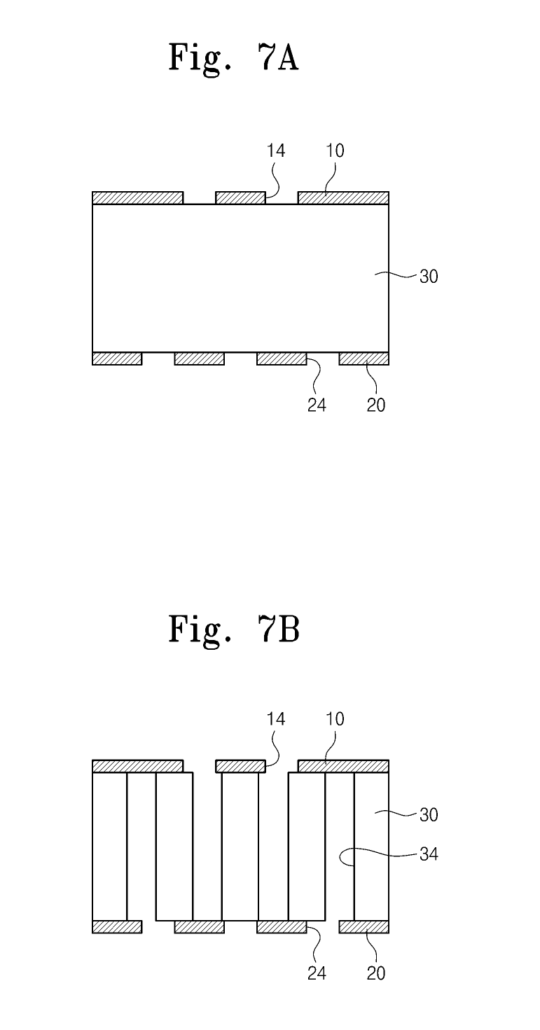

FIG. 6 is a plan view illustrating an upper electrode and a lower electrode of a buried capacitor according to further another embodiment of the present invention. FIG. 7A is a sectional view illustrating a buried capacitor including the upper electrode 10 and the lower electrode 20 of FIG. 6 according to further another embodiment of the present invention. FIG. 7B is a sectional view illustrating a buried capacitor including the upper electrode 10 and the lower electrode 20 of FIG. 6 according to further another embodiment of the present invention.

Referring to FIGS. 6, 7A, and 7B, according to the buried capacitor of this embodiment, the number of the first holes 14 of the upper electrode 10 is different from that of the second holes 24 of the lower electrode 20. The number of the first holes 14 is six in a matrix of 2×3. The number of second holes 24 is nine in a matrix of 3×3. The first hole 14 is arranged not to overlap the second hole 24. The third hole 34 may not be arranged in the dielectric 30 like FIG. 7A, or may be arranged in the dielectric 30 like 7B. At this point, the third hole 34 may not overlap the first hole 14 or may not overlap the second hole 24. Like 7B, air may flow into the third hole 34 and an entire capacitance of the capacitor may be different due to correlation between permittivity of the dielectric layer 30 and permittivity of air.

### Fourth Embodiment

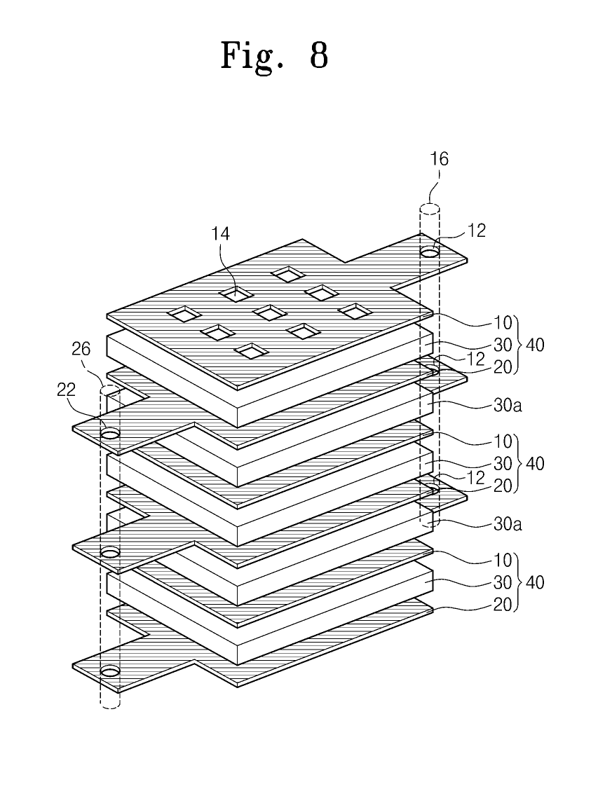

FIG. 8 is an exploded perspective view illustrating a buried capacitor according further another embodiment of the present invention.

Referring to FIG. 8, the buried capacitor like FIG. 3A constitutes one sub capacitor 40, and these sub capacitors 40 may be stacked in a plurality of layers. An auxiliary dielectric layer 30a is interposed between the sub capacitors 40. First via holes 12 of the upper electrodes constituting each sub capacitor 40 are connected through one via 16. Additionally, second via holes 22 of the lower electrodes 20 constituting each sub capacitor 40 are connected through one via 26. The first holes 14 are formed in the upper electrode 10, and the second holes 24 are formed in the lower electrodes 20. In the buried capacitor of this embodiment, the third hole 34 may not be formed in the dielectric layers 30 and 30a (refer to FIG. 3A). Or, the third holes 34 may be formed in the dielectric layers 30 and 30a (refer to FIG. 5A). The number of the holes 14 and 24 may be identical or different, and their positions may or may not overlap each other.

In a buried capacitor according to an embodiment of the present invention, a hole is formed in at least an upper electrode and a lower electrode such that various performances such as a capacitance can be easily adjusted compared to a typical lower electrode without a hole.

In a method of changing a capacitance according to an embodiment of the present invention, a hole is formed in at least an upper electrode and a lower electrode, and also the number of holes, a cross sectional area of a hole, and an area that a hole occupies in the electrodes, and positions of holes are adjusted. As a result, a capacitance can be easily changed.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A buried capacitor comprising:
an upper electrode including at least one first hole;
a lower electrode including at least one second hole; and
a dielectric interposed between the upper electrode and the lower electrode.

2. The buried capacitor of claim 1, wherein the first hole overlaps the second hole.

3. The buried capacitor of claim 1, wherein the number of the first holes is identical to that of the second holes.

4. The buried capacitor of claim 1, wherein the number of the first holes is different from that of the second holes.

5. The buried capacitor of claim 1, wherein the dielectric comprises at least one third hole.

6. The buried capacitor of claim 5, wherein the first, second, and third holes overlap each other.

7. The buried capacitor of claim 1, wherein:
the upper electrode further comprises a first via hole at one end portion; and
the lower electrode further comprises a second via hole at a position that does not overlap the one end portion.

8. The buried capacitor of claim 7, further comprising:
sub capacitors including the upper electrode, the lower electrode, and the dielectric, and being stacked in a plurality of layers;
an auxiliary dielectric interposed between the sub capacitors;
a first via connecting the first via holes of the upper electrodes included in each sub capacitor; and
a second via connecting the second via holes of the lower electrodes included in each sub capacitor.

9. The buried capacitor of claim 1, wherein sectional areas of the first hole and the second hole have a polygonal or circular form.

10. A method of changing a capacitance of a buried capacitor, the buried capacitor including an upper electrode, a lower electrode, and a dielectric, the upper and lower electrodes having predetermined horizontal and vertical lengths and facing each other, the dielectric being interposed between the upper and lower electrodes, the method comprising:
disposing at least one first hole in the upper electrode; and
disposing at least one second hole in the lower electrode.

11. The method of claim 10, wherein:
the disposing of the at least one first hole in the upper electrode comprises changing a sectional area of the first hole; and
the disposing of the at least one second hole in the lower electrode comprises changing a sectional area of the second hole.

12. The method of claim 10, wherein:
the disposing of the at least one first hole in the upper electrode comprises changing the number of the first holes; and
the disposing of the at least one second hole in the lower electrode comprises changing the number of the second holes.

13. The method of claim 10, wherein:
the disposing of the at least one first hole in the upper electrode comprises changing positions of the first holes; and
the disposing of the at least one second hole on the lower electrode comprises changing positions of the second holes.

14. The method of claim 10, further comprising disposing at least one third hole in the dielectric.

15. A method of manufacturing a buried capacitor, the method comprising:
forming an upper electrode on an upper insulation layer, the upper electrode including at least one first hole;
forming a lower electrode on a lower insulation layer, the lower electrode including at least one second hole;
laminating the upper insulation layer on the lower insulation layer; and
performing a cofiring process to thermally melt and bond the upper insulation layer and the lower insulation layer.

16. The method of claim 15, further comprising forming a third hole in the upper insulation layer to overlap the first hole.
